(19) United States
(12) Patent Application Publication
(10) Pub. No.: US 2024/0104936 A1
(43) Pub. Date: Mar. 28, 2024

(54) OBJECT DETECTION DEVICE, OBJECT DETECTION METHOD, AND STORAGE MEDIUM

(71) Applicant: HONDA MOTOR CO., LTD., Tokyo (JP)

(72) Inventor: Masamitsu Tsuchiya, Wako-shi (JP)

(21) Appl. No.: 18/372,182

(22) Filed: Sep. 25, 2023

(30) Foreign Application Priority Data
Sep. 28, 2022 (JP) 2022-154768

(51) Int. Cl. G06V 20/58; G06T 3/40; G06V 10/25; G06V 10/75

(52) U.S. Cl. CPC G06V 20/58; G06T 3/4053; G06V 10/25; G06V 10/751; G06V 2201/07

(57) ABSTRACT

An object detection device includes a storage medium configured to store computer-readable instructions, and a processor connected to the storage medium, in which the processor executes the computer-readable instructions to execute acquiring a captured image of a surface along which a mobile object is able to travel, which is captured with an inclination with respect to the surface, generating a low-resolution image obtained by lowering image quality of the captured image, defining a plurality of partial area sets each having partial areas in the low-resolution image, and deriving a total value obtained by totalizing differences in feature amount between the partial areas included in each of the plurality of partial area sets and partial areas in the vicinity to extract a point of interest on the basis of the total value, each of the plurality of partial area sets is defined to include a plurality of partial areas in a target area of each partial area set, and the target area is obtained by cutting out a part of the low-resolution image limited in a vertical direction so that at least a part thereof does not overlap with another partial area set in the vertical direction.

### CROSS-REFERENCE TO RELATED APPLICATION

Priority is claimed on Japanese Patent Application No. 2022-154768, filed Sep. 28, 2022, the content of which is incorporated herein by reference.

### BACKGROUND

### Field of the Invention

The present invention relates to an object detection device, an object detection method, and a storage medium.

### Description of Related Art

Conventionally, an invention of a traveling obstacle detection system that divides an area of an object in a monitoring area such as a road obtained by photographing into blocks, extracts a local feature amount for each block, and determines the presence or absence of obstacles on the basis of the extracted local feature amount has been disclosed (Japanese Unexamined Patent Application, First Publication No. 2019-124986).

### SUMMARY

In the conventional technology, there have been cases where the processing load becomes excessive and the accuracy is not sufficient.

The present invention has been made in consideration of such circumstances, and an object thereof is to provide an object detection device, an object detection method, and a storage medium capable of suitably detecting an object while reducing the processing load.

The object detection device, the object detection method, and the storage medium according to the present invention have adopted the following configurations.
(1): An object detection device according to one aspect of the present invention includes a storage medium configured to store computer-readable instructions, and a processor connected to the storage medium, in which the processor executes the computer-readable instructions to execute acquiring a captured image of a surface along which a mobile object is able to travel, which is captured with an inclination with respect to the surface, generating a low-resolution image obtained by lowering image quality of the captured image, defining a plurality of partial area sets each having partial areas in the low-resolution image, and deriving a total value obtained by totalizing differences in feature amount between the partial areas included in each of the plurality of partial area sets and partial areas in the vicinity to extract a point of interest on the basis of the total value, each of the plurality of partial area sets is defined to include a plurality of partial areas in a target area of each partial area set, and the target area is obtained by cutting out a part of the low-resolution image limited in a vertical direction so that at least a part thereof does not overlap with another partial area set in the vertical direction.
(2): In the aspect of (1) described above, the processor may define the plurality of partial area sets so that the number of pixels in the partial area increases as the partial area is defined to be closer to a front side of the low-resolution image among the plurality of partial area sets.
(3): In the aspect of (1) described above, the processor may derive the total value by totalizing differences in feature amount between the partial areas included in each of the partial areas included in each of the plurality of partial area sets and other vertically, horizontally, and diagonally adjacent partial areas.
(4): In the aspect of (3) described above, the processor may further add, for the partial areas included in each of the plurality of partial area sets, a difference in feature amount between the vertically adjacent partial areas, a difference in feature amount between the horizontally adjacent partial areas, and a difference in feature amount between the diagonally adjacent partial areas to the total value.
(5): In the aspect of (1) described above, the processor may further perform high-resolution processing on the point of interest in the captured image to determine whether an object on a road is an object with which a mobile object needs to avoid contact.
(6): In the aspect of (1) described above, the object detection device may be mounted on a mobile object, and the processor may change an aspect ratio of the partial area on the basis of an environment in which the mobile object is placed.
(7): In the aspect of (6) described above, when a speed of the mobile object is greater than a reference speed, the processor may change the aspect ratio of the partial area to be vertically longer than when the speed of the mobile object is equal to or less than the reference speed.
(8): In the aspect of (6) described above, when a turning angle of the mobile object is greater than a reference angle, the processor may change the aspect ratio of the partial area to be horizontally longer than when the turning angle of the mobile object is equal to or less than the reference angle.
(9): In the aspect of (6) described above, when the mobile object is on a road surface with an upward gradient equal to or greater than a predetermined gradient, the processor may change the aspect ratio of the partial area to be vertically longer than when the mobile object is not on a road surface with an upward gradient equal to or greater than the predetermined gradient.
(10): In the aspect of (6) described above, when the mobile object is on a road surface with a downward gradient equal to or greater than a predetermined gradient, the processor may change the aspect ratio of the partial area to be horizontally longer than when the mobile object is not on a road surface with a downward gradient equal to or greater than the predetermined gradient.
(11): In the aspect of (1) described above, the processor may define the partial area in a horizontally long rectangular shape.
(12): In the aspect of (1) described above, the processor may regard the total value less than a lower limit as zero and extract the point of interest.
(13): An object detection method according to another aspect of the present invention is an object detection method executed using a computer, and includes acquiring a captured image of a surface along which a mobile object is able to travel, which is captured with an inclination with respect to the surface, generating a low-resolution image obtained by lowering image quality of the captured image, defining a plurality of partial area sets each having partial areas in the low-resolution image, and deriving a total value obtained by totalizing differences in feature amount between the partial areas included in each of the plurality of partial area sets and partial areas in the vicinity to extract a point of interest on the basis of the total value, in which each of the plurality of partial area sets is defined to include a plurality of partial areas in a target area of each partial area set, and the target area is obtained by cutting out a part of the low-resolution image limited in a vertical direction so that at least a part thereof does not overlap with another partial area set in the vertical direction.
(14): A storage medium according to still another aspect of the present invention is a computer-readable non-transitory storage medium which has stored a program executed by a computer, and the program causes the computer to execute acquiring a captured image of a surface along which a mobile object is able to travel, which is captured with an inclination with respect to the surface, generating a low-resolution image obtained by lowering image quality of the captured image, defining a plurality of partial area sets each having partial areas in the low-resolution image, and deriving a total value obtained by totalizing differences in feature amount between the partial areas included in each of the plurality of partial area sets and partial areas in the vicinity to extract a point of interest on the basis of the total value, in which each of the plurality of partial area sets is defined to include a plurality of partial areas in a target area of each partial area set, and the target area is obtained by cutting out a part of the low-resolution image limited in a vertical direction so that at least a part thereof does not overlap with another partial area set in the vertical direction.

According to the aspects (1) to (14) described above, it is possible to suitably detect an object while reducing the processing load.

### BRIEF DESCRIPTION OF THE DRAWINGS

FIG. 1 is a diagram which shows an example of a configuration of an object detection device and peripheral devices.

FIG. 2 is a diagram which schematically shows a function of each unit of the object detection device.

FIG. 3 is a diagram for describing processing of a mask area determination unit, a grid definition unit, and an extraction unit.

FIG. 4 is a diagram for describing processing of a feature amount difference calculation unit, a totalization unit, and an addition unit.

FIG. 5 is a diagram which shows a definition example of a peripheral grid.

FIG. 6 is a diagram which shows an example of rules for selecting a comparison target grid and a comparison source grid.

FIG. 7 is a diagram which shows another example of rules for selecting a comparison target grid and a comparison source grid.

FIG. 8 is a diagram for describing processing of an addition unit and a synthesizing unit.

FIG. 9 is a diagram for describing processing of a point-of-interest extraction unit.

### DESCRIPTION OF EMBODIMENTS

Hereinafter, embodiments of an object detection device, an object detection method, and a storage medium of the present invention will be described with reference to the drawings. An object detection device is mounted in, for example, a mobile object. The mobile object is, for example, a four-wheeled vehicle, a two-wheeled vehicle, a micro-mobility, a robot that moves by itself, a flying object such as a drone, or a portable device such as a smart-phone that is placed on a mobile object that moves by itself, or that moves by being carried by a person. In the following description, the mobile object is assumed to be a four-wheeled vehicle, and the mobile object will be referred to as a “vehicle.” The object detection device is not limited to a device mounted on a mobile object, and may be a device that performs processing described below on the basis of a captured image captured by a fixed-point observation camera or a smartphone camera.

### Configuration

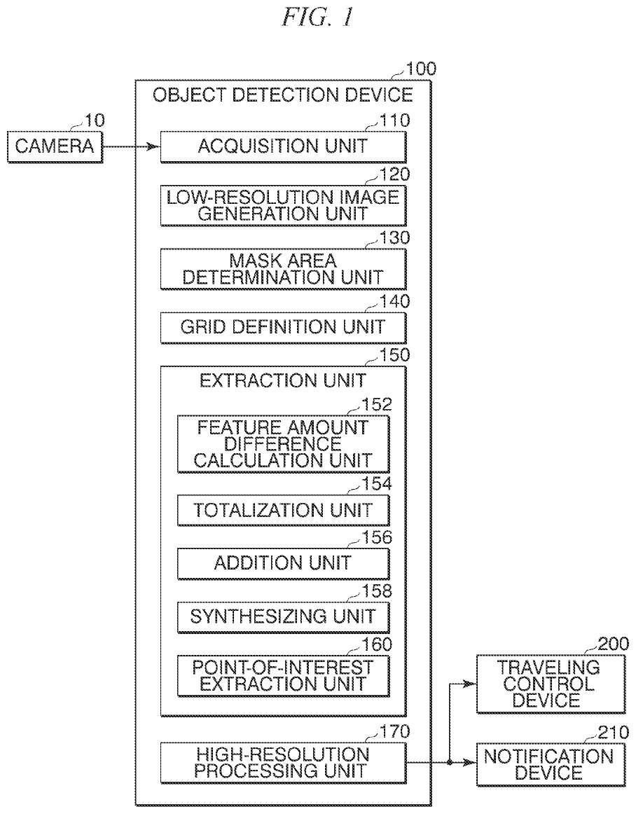

FIG. 1 is a diagram which shows an example of a configuration of an object detection device 100 and peripheral devices. The object detection device 100 communicates with a camera 10, a traveling control device 200, a notification device 210, and the like.

The camera 10 is attached to a rear surface of a windshield of the vehicle or the like, captures an image of at least a road in a traveling direction of the vehicle, and outputs the captured image to the object detection device 100. A sensor fusion device or the like may be interposed between the camera 10 and the object detection device 100, but description thereof will be omitted. The camera 10 is an example of a device that captures an image of “a surface along which the mobile object can travel with an inclination with respect to the surface.” The mobile object is as described above. Examples of the “surface along which a mobile object can travel” may include corridors and floor surfaces of rooms when mobile objects move indoors as well as outdoor surfaces such as roads and public open spaces. “With an inclination with respect to the surface” means that the image is not captured by a flying object as if it were looking down straight down from the sky. In other words, the image is captured with an inclination of a predetermined angle or more. Specifically, it refers to capturing an image from a height of, for example, less than 5 [m] so that a ground plane is included in the captured image. In other words, “with an inclination with respect to the surface” refers to, for example, capturing an image at a depression angle of less than about 20 degrees from the height of less than 5 [m]. The camera 10 may be mounted on a mobile object that moves in contact with the “surface,” or may be mounted on a drone or the like which flies at a low altitude.

The traveling control device 200 is, for example, an automatic driving control device that allows the vehicle travel autonomously, a driving assistance device that performs intervehicle distance control, automatic brake control, automatic lane change control, and the like, or the like. The notification device 210 is a speaker, a vibrator, a light emitting device, a display device, or the like for outputting information to an occupant of the vehicle.

The object detection device 100 includes, for example, an acquisition unit 110, a low-resolution image generation unit 120, a grid definition unit 140, an extraction unit 150, and a high-resolution processing unit 170. The extraction unit 150 includes a feature amount difference calculation unit 152, a totalization unit 154, an addition unit 156, a synthesizing unit 158, and a point-of-interest extraction unit 160. These components are each realized by, for example, a hardware processor such as a central processing unit (CPU) executing a program (software). Some or all of these components may be realized by hardware (a circuit unit; including circuitry) such as large scale integration (LSI), an application specific integrated circuit (ASIC), a field-programmable gate array (FPGA), or a graphics processing unit (GPU), or may be realized by software and hardware in cooperation. A program may be stored in advance in a storage device (a storage device having a non-transitory storage medium) such as a hard disk drive (HDD) or flash memory, or may be stored in a detachable storage medium (non-transitory storage medium) such as a DVD or a CD-ROM and installed by the storage medium being attached to a drive device.

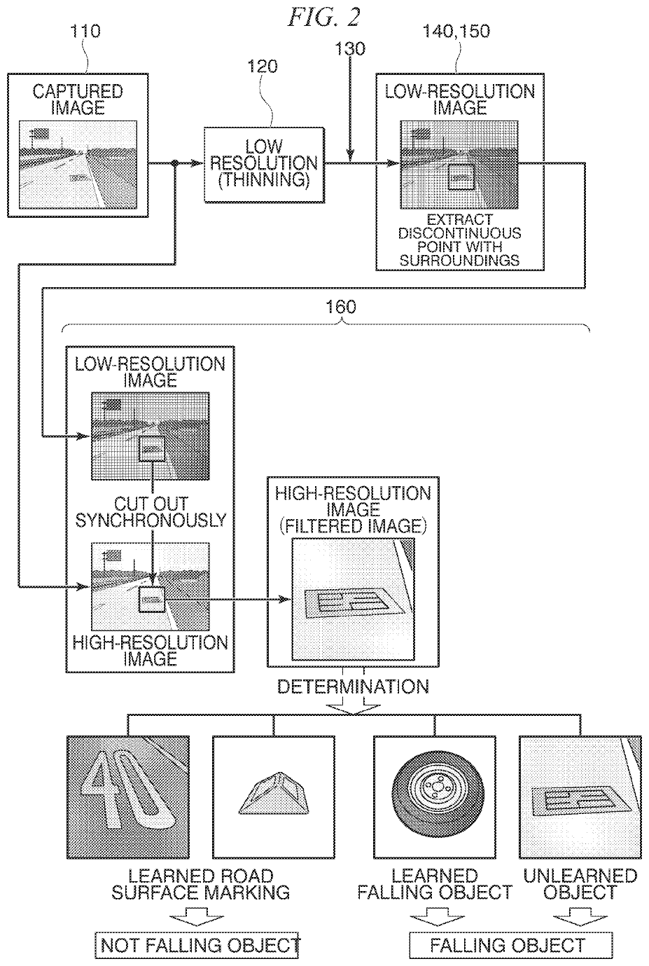

FIG. 2 is a diagram which schematically shows functions of each part of the object detection device 100. Hereinafter, each part of the object detection device 100 will be described with reference to FIG. 2. The acquisition unit 110 acquires a captured image from the camera 10. The acquisition unit 110 stores (data of) the acquired captured image in a working memory such as a random access memory (RAM).

The low-resolution image generation unit 120 performs thinning processing on the captured image to generate a low-resolution image obtained by lowering image quality of the captured image. A low-resolution image is, for example, an image with fewer pixels than the captured image.

A mask area determination unit 130 determines mask areas that are not processed by the grid definition unit 140 and below. Details will be described below.

The grid definition unit 140 defines a plurality of partial area sets in the low-resolution image. To “define” is to determine a boundary for the low-resolution image. Each of the plurality of partial area sets is defined by cutting out a plurality of partial areas (hereafter referred to as a grid) from the low-resolution image. The grid is set, for example, in a rectangular shape without a gap. The grid is, for example, a square, but it can also be a horizontally long rectangle. In addition, as will be described below, the grid definition unit 140 may change a size or an aspect ratio of the grid on the basis of an environment in which the mobile object is placed. The grid definition unit 140 defines the plurality of partial area sets so that the number of pixels in a front grid increases (that is, becomes large) as the grid defined to be closer to the front side (a lower side in the image) of the low-resolution image in a partial area set. Hereinafter, the plurality of partial area sets may be referred to as a first partial area set PA1, a second partial area set PA2, . . . , and a k^{th} partial area set PAk. Detailed functions of the grid definition unit 140 will be described below.

The extraction unit 150 derives a total value obtained by totalizing differences in feature value between grids included in each of the plurality of partial area sets and the peripheral grids, and adds the total values among the plurality of partial area sets to extract a point of interest (a discontinuous point with the surroundings in FIG. 2). Detailed functions of each part of the extraction unit 150 will be described below.

The high-resolution processing unit 170 cuts out (cuts out synchronously in FIG. 2) a portion corresponding to the point of interest in the captured image, performs high-resolution processing on this, and determines whether an object on a road is an object with which the vehicle needs to avoid contact. The high-resolution processing unit 170 uses a learned model that recognizes, for example, road surface markings (an example of objects with which the vehicle does not need to avoid contact) and falling objects (an example of objects with which the vehicle needs to avoid contact) from the image to determine whether the image projected at the point of interest is a road surface marking, a falling object, or an unknown object (an unlearned object). At this time, the high-resolution processing unit 170 may perform processing by narrowing down to the portions recognized to correspond to road surface markings and falling objects among points of interest in the captured image.

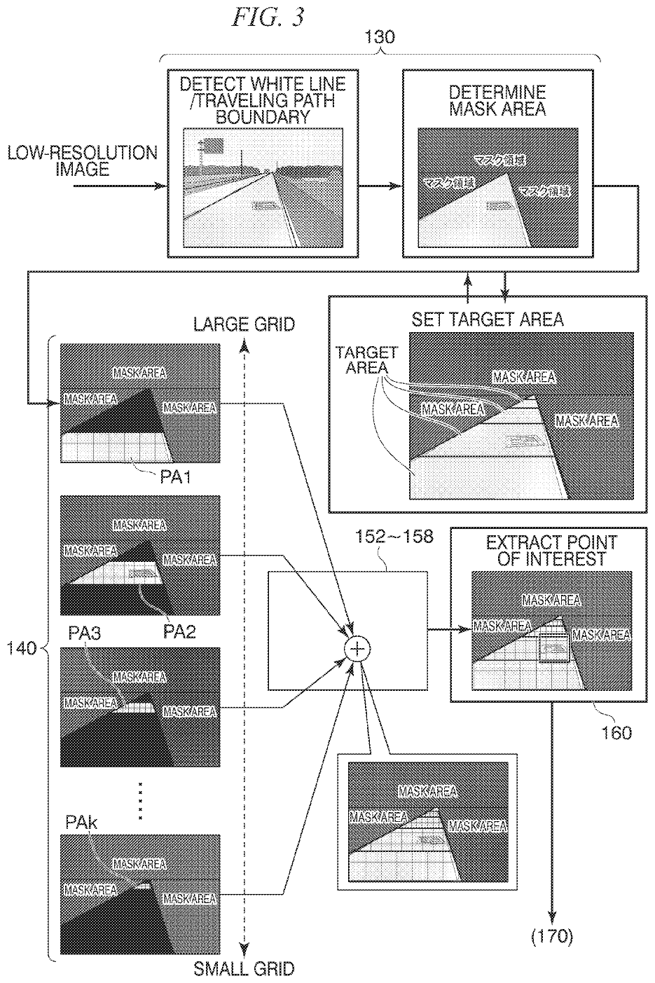

FIG. 3 is a diagram for describing processing of the mask area determination unit 130, the grid definition unit 140, and the extraction unit 150. The mask area determination unit 130 extracts, for example, edge points in a horizontal direction from the low-resolution image, and detects positions of road division lines, road shoulders, and the like (white lines, road boundaries) in the image by connecting the edge points that are arranged in a straight line. Then, an area sandwiched by left and right road division lines, and the like and including a central point in a left-right direction on the front side of the image is detected as a traveling path of the vehicle. Next, the mask area determination unit 130 designates portions other than the traveling path of the vehicle (above a vanishing point where the road division lines or the like intersect on a far side, and left and right end portions of the road division lines) as mask areas. The grid definition unit 140 and the extraction unit 150 perform processing by excluding the mask areas.

The grid definition unit 140 defines each of the plurality of partial area sets so that a target area of each partial area set includes a plurality of partial areas. The target area is obtained by cutting out a part of the low-resolution image excluding the mask area and limited in a vertical direction so that at least a part thereof does not overlap with another partial area set in the vertical direction. In the following description, it is assumed that the partial area set is cut out so as not to overlap with other partial area sets in the vertical direction. As described above, the grid definition unit 140 defines the partial area sets as a first partial area set PA1 having the largest number of pixels in a grid, a second partial area set PA2 having the next largest number of pixels in a grid, and, in the following order, up to a k^{th} partial area set PAk having the smallest number of pixels in a grid.

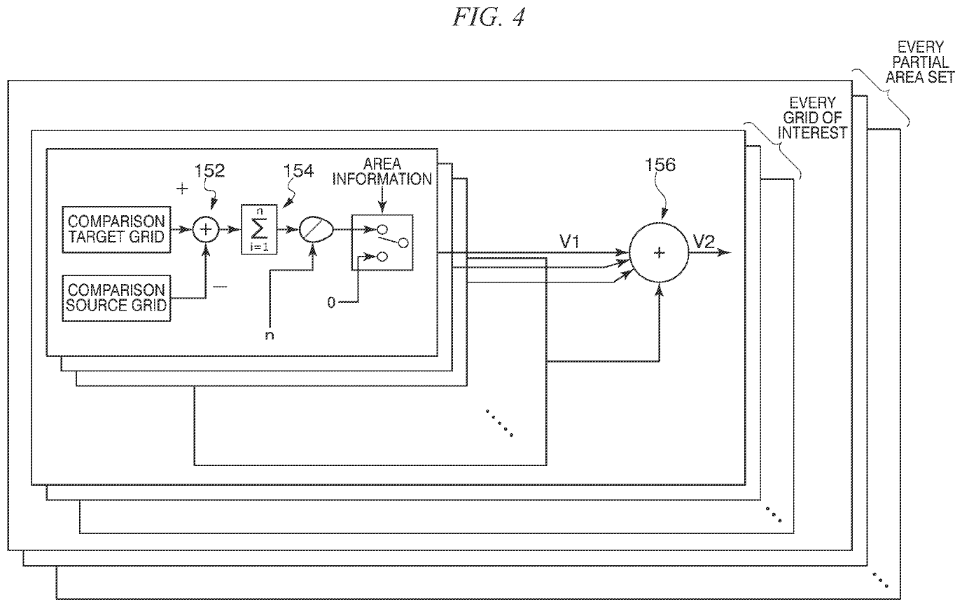

In the following description, processing of the feature amount difference calculation unit 152, the totalization unit 154, and the addition unit 156 will be described. The processing of these functional units, which will be described with reference to FIGS. 4 to 7, is performed after first selecting one partial area set and selecting a grid of interest one by one in the selected partial area set. Then, when all the grids of the selected partial area set are selected as the grid of interest and the processing is completed, a next partial area set is selected and the same processing is performed. When the processing is completed for all partial area sets, the synthesizing unit 158 synthesizes (combines) results of the processing of each partial area set to generate extraction target data PT, which is a single image, and pass it to the point-of-interest extraction unit 160. When a partial region set is defined so as to partially overlap with another partial area set, the synthesizing unit 158 may add or average the results of the processing of the overlapping portions.

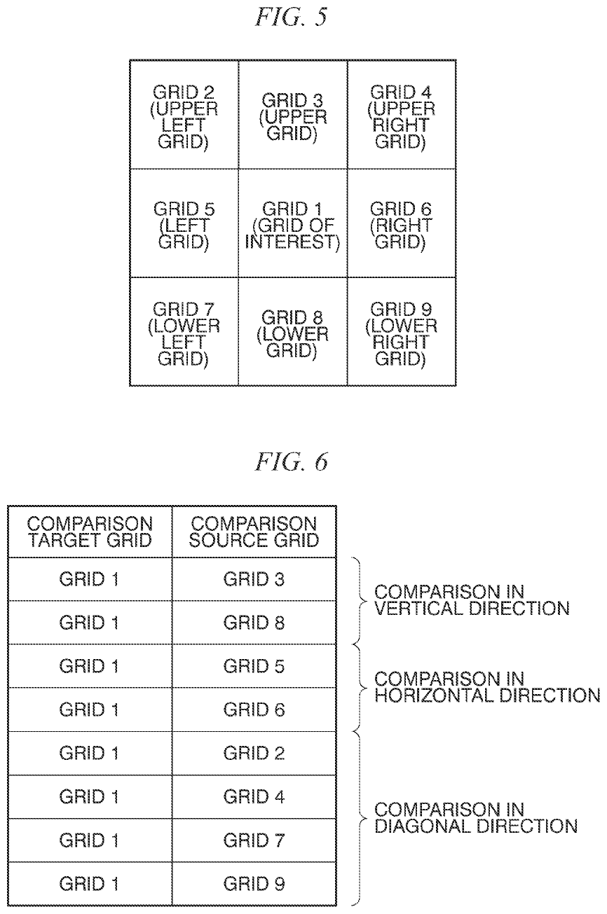

FIG. 4 is a diagram for describing the processing of the feature amount difference calculation unit 152, the totalization unit 154, and the addition unit 156. The feature amount difference calculation unit 152 calculates a difference in feature amount for each pixel between a comparison target grid and a comparison source grid. The feature amount is, for example, a luminance value of each of R, G, and B components, and a set of R, G, and B is assumed to be one pixel. A comparison target grid and a comparison source grid are selected from a grid of interest and peripheral grids. FIG. 5 is a diagram which shows a definition example of the peripheral grid. As shown in FIG. 5, grids 2 to 9 adjacent to a grid of interest in the vertical, horizontal, and diagonal directions are defined as peripheral grids. A method of selecting peripheral grids (peripheral partial areas) is not limited to this, and the top, bottom, left, and right grids may be selected as the peripheral grids, or the peripheral grids may be selected by other rules.

For example, a comparison target grid and a comparison source grid are selected in order from a combination shown in FIG. 6. FIG. 6 is a diagram which shows an example of rules for selecting a comparison target grid and a comparison source grid. A comparison target grid is a grid of interest, and a comparison source grid is selected in order from the grids 2 to 9. A relationship between the comparison target grid and the comparison source grid may be reversed. Then, the totalization unit 154 obtains a sum of the differences in feature amount for each pixel and divides it by the number of pixels n in a grid to calculate a first total value V1. The first total value V1 is replaced with zero and output when the grid of interest corresponds to a mask area. That is, the feature amount difference calculation unit 152, the totalization unit 154, and the addition unit 156 perform processing using a grid 1 as the comparison target grid and a grid 3 as the comparison source grid, perform processing using a grid 1 as the comparison target grid and a grid 8 as the comparison source grid, perform processing using a grid 1 as the comparison target grid and a grid 5 as the comparison source grid, perform processing using a grid 1 as the comparison target grid and a grid 6 as the comparison source grid, perform processing using a grid 1 as the comparison target grid and a grid 2 as the comparison source grid, perform processing using a grid 1 as the comparison target grid and a grid 4 as the comparison source grid, perform processing using a grid 1 as the comparison target grid and a grid 7 as the comparison source grid, and perform processing using a grid 1 as the comparison target grid and a grid 9 as the comparison source grid in parallel or sequentially.

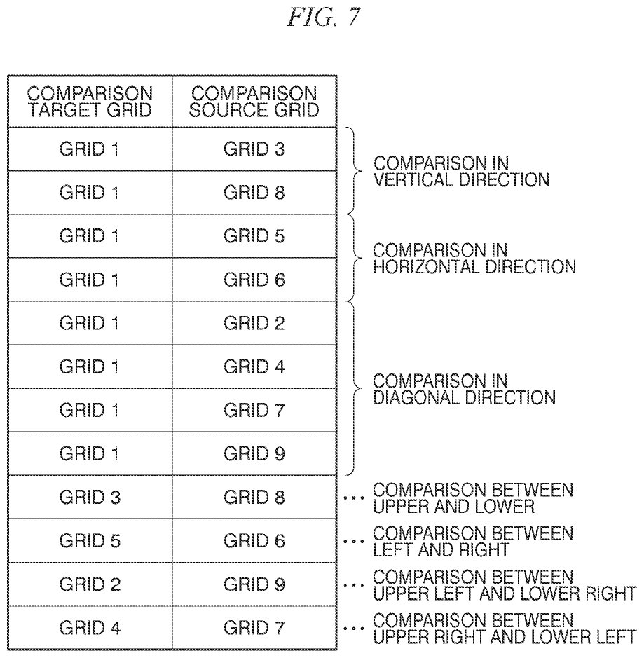

The comparison target grid and the comparison source grid may be selected in order among the combinations shown in FIG. 7. FIG. 7 is a diagram which shows another example of the rules for selecting a comparison target grid and a comparison source grid. A combination of a comparison target grid and a comparison source grid is not limited to a combination of a target grid and the peripheral grids, and may also include a combination of peripheral grids (in particular, combinations of an upper grid and a lower grid, a left grid and a right grid, an upper left grid and a lower right grid, an upper right grid and a bottom left grid).

More specifically, a method of calculating the difference in feature amount will be described. For example, the following patterns 1 to 4 are conceivable as the method of calculating the difference in feature amount. In the following description, a pixel identification number in each of a comparison target grid and a comparison source grid is represented by i (i=1 to k; k is the number of pixels in each of the comparison target grid and the comparison source grid).

### (Pattern 1)

The feature amount difference calculation unit 152 calculates, for example, a difference ΔRi in luminance of an R component, a difference ΔGi in luminance of a G component, and a difference ΔBi in luminance of a B component between pixels at the same position in both the comparison target grid and the comparison source grid (i=1 to k as described above). Then, each pixel feature amount Ppi=ΔRi²+ΔGi²+ΔBi² is obtained for each pixel, and a maximum value or an average value of each pixel feature amount Ppi is calculated as a difference in feature amount between the comparison target grid and the comparison source grid.

### (Pattern 2)

The feature amount difference calculation unit 152 calculates, for example, a statistical value of luminance of the R component (refers to an average value, a median value, a mode, or the like) Raa, a statistical value of luminance of the G component (the same as above) Gaa, and a statistical value of luminance of the B component (the same as above) Baa of each pixel in the comparison target grid, calculates a statistical value of luminance of the R component (the same as above) Rab, a statistical value of luminance of the G component (the same as above) Gab, and a statistical value of luminance of the B component (the same as above) Bab of each pixel in the comparison source grid, and obtains these differences ΔRa(=Raa−Rab), ΔGa(=Gaa−Gab), and ΔBa(=Baa−Bab). Then, ΔRa²+ΔGa²+ΔBa², which is a sum of squares of the luminance differences, or a maximum value Max(ΔRa², ΔGa², ΔBa²) of the squares of the luminance differences is calculated as the difference in feature amount between the comparison target grid and the comparison source grid.

### (Pattern 3)

The feature amount difference calculation unit 152 calculates, for example, a first index value W1ai(=(R−B)/(R+G+B)) obtained by dividing the difference in luminance between the R component and the B component by a sum of luminance of each of the R, G, and B components, and a second index value W2ai(=(R−G)/(R+G+B)) obtained by dividing the difference in luminance between the R component and the G component by the sum of luminance of each of the R, G, and B components for each pixel i in the comparison target grid. In addition, the feature amount difference calculation unit 152 calculates, for example, a first index value W1bi(=(R−B)/(R+G+B)) obtained by dividing the difference in luminance between the R component and the B component by the sum of luminance of each of the R, G, and B components, and a second index value W2bi(=(R−G)/(R+G+B)) obtained by dividing the difference in luminance between the R component and the G component by the sum of luminance of each of the R, G, and B components for each pixel i in the comparison source grid. Next, the feature amount difference calculation unit 152 calculates each pixel feature amount Ppi=(W1ai−W1bi)²+(W2ai−W2bi)². Then, the feature amount difference calculation unit 152 calculates a maximum value or an average value of each pixel feature amount Ppi as the difference in feature amount between the comparison target grid and the comparison source grid. By combining the first index value and the second index value, it is possible to express a balance of the RGB components in each pixel. In the same manner as above, for example, the luminance of each of the R, G, and B component may be defined as a magnitude of a vector shifted by 120 degrees, and a vector sum may be used in the same manner as a combination of the first index value and the second index value.

### (Pattern 4)

The feature amount difference calculation unit 152 calculates, for example, the statistical value of the luminance of the R component (the same) Raa, the statistical value of the luminance of the G component (the same) Gaa, and the statistical value of the luminance of the B component (the same) Baa of each pixel in the comparison target grid, and calculates the statistical value of the luminance of the R component (the same) Rab, the statistical value of the luminance of the G component (the same) Gab, and the statistical value of the luminance of the B component (the same) Bab of each pixel in the comparison source grid. Next, the feature amount difference calculation unit 152 calculates a third index value W3a(=(Raa−Baa)/(Raa+Gaa+Baa)) obtained by dividing the difference between a statistic value Raa of the luminance of the R component and a statistic value Baa of the luminance of the B component by the sum of the statistic values of the luminance of each of the R, G, and B components, and a fourth index value W4a(=(Raa−Gaa)/(Raa+Gaa+Baa)) obtained by dividing the difference between the statistic value Raa of the luminance of the R component and a statistic value Gaa of the luminance of the G component by the sum of the statistic values of the luminance of each of the R, G, and B components for the comparison target grid. Similarly, the feature amount difference calculation unit 152 calculates a third index value W3b(=(Rab−Bab)/(Rab+Gab+Bab)) obtained by dividing the difference between a statistic value Rab of the luminance of the R component and a statistic value Bab of the luminance of the B component by the sum of the statistic values of the luminance of each of the R, G, and B components, and a fourth index value W4b(=(Rab−Gab)/(Rab+Gab+Bab)) obtained by dividing the difference between the statistic value Rab of the luminance of the R component and a statistic value Gab of the luminance of the G component by the sum of the statistic values of the luminance of each of the R, G, and B components in the comparison source grid. Then, the feature amount difference calculation unit 152 obtains a difference ΔW3 between the third index value W3a of the comparison target grid and the third index value W3b of the comparison source grid, and a difference ΔW4 between the fourth index value W4a of the comparison target grid and the fourth index value W4a of the comparison source grid, and calculates a sum of squares of these ΔW3²+ΔW4² or a maximum value of the squares Max(ΔW3² and ΔW4²) as the difference in feature amount between the comparison target grid and the comparison source grid.

When an image to be processed is a black and white image, the feature amount difference calculation unit 152 may simply calculate a difference in luminance value as the difference in feature amount between the comparison target grid and the comparison source grid. In addition, when the image to be processed is an RGB image, the RGB image may be converted into a black and white image and a difference in trajectory values may be calculated as the difference in feature amount between the comparison target grid and the comparison source grid.

Returning to FIG. 4, the addition unit 156 calculates a second total value V2 in consideration of the first total value V1 obtained corresponding to a grid of interest. The second total value V2 is an example of a “total value” in the claims. When processing of obtaining the second total value V2 while changing a grid of interest is completed, data in which the second total value V2 is set for all grids is generated for each partial area set.

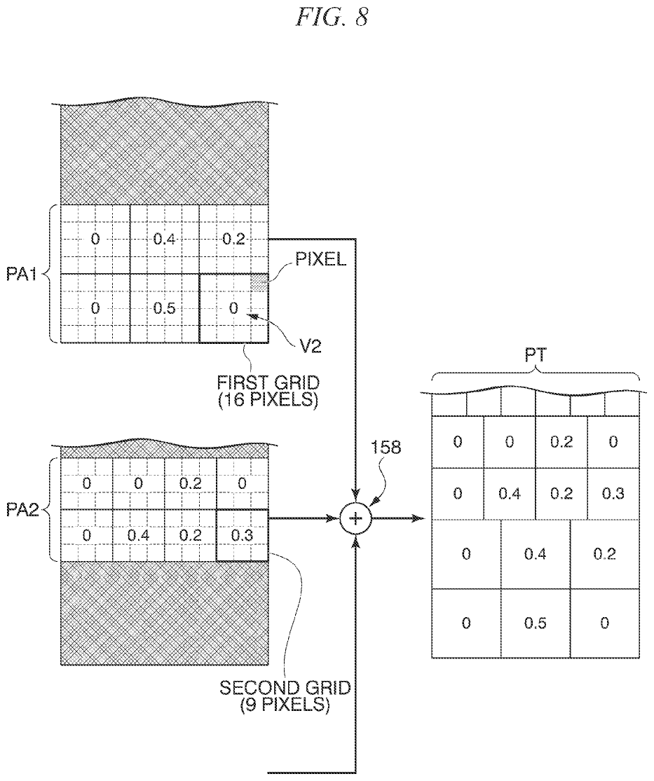

When the data in which the second total value V2 is set for all grids is generated, the synthesizing unit 158 combines them to generate extraction target data PT which is one image. FIG. 8 is a diagram for describing processing of the addition unit 156 and the synthesizing unit 158. In FIG. 8, the smallest rectangle is one pixel of the low-resolution image. Here, to simplify the description, the first partial area set PA1 and the second partial area set PA2 are shown as representative partial area sets, and their sizes in the horizontal direction are assumed to be much smaller than they actually are. It is also assumed that the second total value V2 has been normalized in some stages so as to have a value between zero and one. In the shown example, the first partial area set PA1 is a set of first grids made up of 16 pixels, and the second partial area set PA2 is a set of second grids made up of 9 pixels. Examples of 16 pixels, 9 pixels, and 4 pixels as a grid size have been shown. When the pattern 2 or pattern 4 described above is adopted as a calculation method for the difference in feature amount, setting the number of pixels on one side to a power of 2, such as 4 pixels, 16 pixels, or 64 pixels, as a size of a grid, can reduce a calculation load of statistical values.

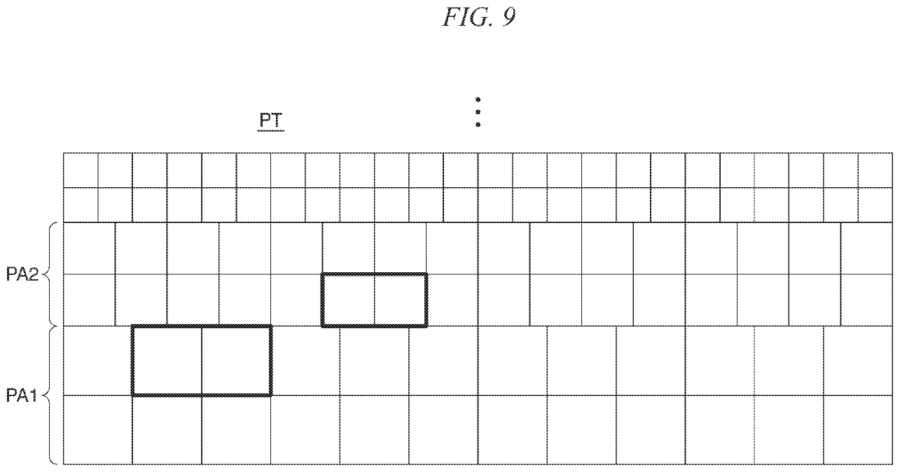

FIG. 9 is a diagram for describing processing of the point-of-interest extraction unit 160. For the data PT to be processed, the point-of-interest extraction unit 160 sets, for example, a search area WA corresponding to the size of a grid for each area having the same size of a grid (that is, each area divided by which a partial area set data is derived from), and extracts a search area WA in which a sum of the second total values V2 in the search area WA is equal to or greater than a reference value as the point of interest. In this case, the search area WA is set to a fixed size such as 2 grids horizontally and 1 grid vertically.

Alternatively, the point-of-interest extraction unit 160 may set the search area WA to a variable size, in which case the point-of-interest extraction unit 160 may extract a search area WA in which a difference in the second total value V2 between an inside of the search area WA and peripheral grids of the search area WA is locally largest as the point of interest. The search area WA that is locally largest may appear at plurality of locations.

In any case, the point-of-interest extraction unit 160 may replace the second total value V2, which is less than a lower limit, with zero (regard it as zero) and perform the processing described above.

As described above, the high-resolution processing unit 170 performs high-resolution processing on an area obtained by applying only a position of the point of interest to the captured image to determine whether an object on the road is an object with which the vehicle needs to avoid contact.

A result of the determination of the high-resolution processing unit 170 is output to the traveling control device 200 and/or the notification device 210. The traveling control device 200 performs automatic brake control, automatic steering control, or the like to avoid contact of the vehicle with an object determined as a “falling object” (actually an area on the image). The notification device 210 outputs an alarm in various methods when time to collision (TTC) between an object determined as a “falling object” (the same as above) and the vehicle falls below a threshold value.

According to the embodiment described above, it is possible to maintain a high detection accuracy while reducing a processing load by providing the acquisition unit 110 that acquires a captured image of at least the road in the traveling direction of the vehicle, the low-resolution image generation unit 120 that generates a low-resolution image obtained by degrading an image quality of the captured image, the grid definition unit 140 that defines one or more partial area sets, and the extraction unit 150 that derives a total value obtained by totalizing the difference in feature amount between the partial areas included in each of one or more partial area sets and partial areas in the vicinity, and extracts a point of interest on the basis of the total value.

If the processing performed by the feature amount difference calculation unit 152 and the totalization unit 154 is set to be performed on the captured image as it is, there are concerns that the processing load may increase as the number of pixels increased, and that the traveling control device 200 and the notification device 210 may not be able to cope with an approach of a falling object in time. Regarding this point, the object detection device 100 of the embodiment can detect an object while reducing the processing load by performing processing after generating a low-resolution image.

Furthermore, according to the embodiment, since the grid definition unit 140 defines a plurality of partial area sets so that the number of pixels in a grid differs between the plurality of partial area sets, and the extraction unit 150 extracts a point of interest by adding the total value for each pixel among the plurality of partial area sets, it is possible to improve robustness of detection performance against a variation in size of falling objects. When the processing is simply performed with a low-resolution image, even though there is a concern that the image quality is degraded so that a presence of a falling object may be unrecognizable, it is expected that a falling object will appear as a feature amount in a grid of any size by the measures described above according to the present embodiment. As described above, according to the object detection device 100 of the embodiment, it is possible to maintain high detection accuracy while reducing the processing load.

### Another Example of Grid Definition

The grid definition unit 140 may change the aspect ratio of a grid on the basis of an environment in which the vehicle is placed. In this case, the aspect ratio of the search area WA is necessarily changed in the same manner. In this case, the object detection device acquires various types of information necessary for the following processing from in-vehicle sensors such as a vehicle speed sensor, a steering angle sensor, a yaw rate sensor, and a gradient sensor.

For example, when the speed V of the vehicle is greater than the reference speed V1, the grid definition unit 140 changes the aspect ratio of a grid to be vertically longer than when the speed V of the vehicle is equal to or less than the reference speed V1. This is because, as the speed V increases, a probability that an image of the camera 10 is vertically blurred due to a vibration generated in the vehicle increases. By changing the aspect ratio of a grid to be vertically longer, even if a group of pixels with a large difference in feature amount from the surroundings are vertically extended due to the blurring of the image, a probability that the extended portion can fit in the grid increases. “Changing the aspect ratio to be vertically longer” may be one of enlarging the size in the vertical direction while maintaining the size in the horizontal direction, enlarging the size in the vertical direction while reducing the size in the horizontal direction, and maintaining the size in the vertical direction while reducing the size in the horizontal direction. “Changing the aspect ratio to be horizontally longer” is the opposite.

In addition, when a turning angle θ of the vehicle is larger than a reference angle θ1, the grid definition unit 140 may change the aspect ratio of a grid to be horizontally longer than when the turning angle θ of the vehicle is equal to or less than the reference angle θ1. Here, it is assumed that the turning angle θ is information on an absolute value with a neutral position of a steering device set to zero. The turning angle θ may be an angular speed or a steering angle. This is because when the turning angle θ of the vehicle increases, a probability that the image of the camera 10 is blurred horizontally due to the turning behavior increases.

In addition, when the vehicle is on a road surface with an upward gradient equal to or larger than a predetermined gradient of φ1, the grid definition unit 140 changes the aspect ratio of a grid to be vertically longer than when the vehicle is not on the road surface with the upward gradient equal to or larger than the predetermined gradient of φ1. Alternatively, when the vehicle is on a road surface with a downward gradient equal to or larger than a predetermined gradient of φ2, it may change the aspect ratio of a grid to be horizontally longer than when the vehicle is not on the road surface with the downward gradient equal to or larger than the predetermined gradient of φ2. Both the gradients φ1 and φ2 are absolute values (positive values for both upward and downward), and may be the same value or different values. This is because while a portion of the image captured by the camera 10 that reflects the road surface is relatively extended to an upper side of the image (that is, the portion of the image that reflects the road surface becomes an image that is vertically extended compared to a flat road) on an upward gradient, the portion of the image captured by the camera 10 that reflects the road surface is relatively extended only to a bottom of the image (that is, the portion of the image that reflects the road surface becomes an image that is vertically compressed compared to the flat road) on a downward gradient.

When the conditions described above occur simultaneously, for example, when the speed V of the vehicle is greater than the reference speed V1 and the vehicle is on a road surface with a downward gradient equal to or larger than the predetermined gradient φ2, the grid definition unit 140 may determine a shape of a grid by canceling out a change in aspect ratio due to the speed V of the vehicle being greater than the reference speed V1 and a change in aspect ratio due to the speed V of the vehicle being on the road surface with the downward gradient equal to or larger than the predetermined gradient of φ2. The same will be applied even though other conditions occur simultaneously.

In addition, since the optimum shape and size of a grid differ depending on a type of a falling object, the grid definition unit 140 may set a plurality of partial area sets with different grid definitions according to an assumed size of a target falling object, and execute processing for them in parallel.

Although a mode for carrying out the present invention has been described above using the embodiment, the present invention is not limited to the embodiment, and various modifications and substitutions can be made within a range not departing from the gist of the present invention.

What is claimed is:

1. An object detection device comprising:
a storage medium configured to store computer-readable instructions, and
a processor connected to the storage medium,
wherein the processor executes the computer-readable instructions to execute
acquiring a captured image of a surface along which a mobile object is able to travel, which is captured with an inclination with respect to the surface,
generating a low-resolution image obtained by lowering image quality of the captured image,
defining a plurality of partial area sets each having partial areas in the low-resolution image, and
deriving a total value obtained by totalizing differences in feature amount between the partial areas included in each of the plurality of partial area sets and partial areas in the vicinity to extract a point of interest on the basis of the total value,
each of the plurality of partial area sets is defined to include a plurality of partial areas in a target area of each partial area set, and
the target area is obtained by cutting out a part of the low-resolution image limited in a vertical direction so that at least a part thereof does not overlap with another partial area set in the vertical direction.

2. The object detection device according to claim 1,
wherein the processor defines the plurality of partial area sets so that the number of pixels in the partial area increases as the partial area is defined to be closer to a front side of the low-resolution image among the plurality of partial area sets.

3. The object detection device according to claim 1,
wherein the processor derives the total value by totalizing differences in feature amount between the partial areas included in each of the partial areas included in each of the plurality of partial area sets and other vertically, horizontally, and diagonally adjacent partial areas.

4. The object detection device according to claim 3,
wherein the processor further adds, for the partial areas included in each of the plurality of partial area sets, a difference in feature amount between the vertically adjacent partial areas, a difference in feature amount between the horizontally adjacent partial areas, and a difference in feature amount between the diagonally adjacent partial areas to the total value.

5. The object detection device according to claim 1,
wherein the processor further performs high-resolution processing on the point of interest in the captured image to determine whether an object on a road is an object with which a mobile object needs to avoid contact.

6. The object detection device according to claim 1,
wherein the object detection device is mounted on a mobile object, and
the processor changes an aspect ratio of the partial area on the basis of an environment in which the mobile object is placed.

7. The object detection device according to claim 6,
wherein, when a speed of the mobile object is greater than a reference speed, the processor changes the aspect ratio of the partial area to be vertically longer than when the speed of the mobile object is equal to or less than the reference speed.

8. The object detection device according to claim 6,
wherein, when a turning angle of the mobile object is greater than a reference angle, the processor changes the aspect ratio of the partial area to be horizontally longer than when the turning angle of the mobile object is equal to or less than the reference angle.

9. The object detection device according to claim 6,
wherein, when the mobile object is on a road surface with an upward gradient equal to or greater than a predetermined gradient, the processor changes the aspect ratio of the partial area to be vertically longer than when the mobile object is not on a road surface with an upward gradient equal to or greater than the predetermined gradient.

10. The object detection device according to claim 6,
wherein, when the mobile object is on a road surface with a downward gradient equal to or greater than a predetermined gradient, the processor changes the aspect ratio of the partial area to be horizontally longer than when the mobile object is not on a road surface with a downward gradient equal to or greater than the predetermined gradient.

11. The object detection device according to claim 1,
wherein the processor defines the partial area in a horizontally long rectangular shape.

12. The object detection device according to claim 1,
wherein the processor regards the total value less than a lower limit as zero and extracts the point of interest.

13. An object detection method executed using a computer, comprising:
acquiring a captured image of a surface along which a mobile object is able to travel, which is captured with an inclination with respect to the surface;
generating a low-resolution image obtained by lowering image quality of the captured image;
defining a plurality of partial area sets each having partial areas in the low-resolution image, and
deriving a total value obtained by totalizing differences in feature amount between the partial areas included in each of the plurality of partial area sets and partial areas in the vicinity to extract a point of interest on the basis of the total value,
wherein each of the plurality of partial area sets is defined to include a plurality of partial areas in a target area of each partial area set, and
the target area is obtained by cutting out a part of the low-resolution image limited in a vertical direction so that at least a part thereof does not overlap with another partial area set in the vertical direction.

14. A computer-readable non-transitory storage medium is a computer-readable non-transitory storage medium which has stored a program executed by a computer, wherein the program causes the computer to execute
acquiring a captured image of a surface along which a mobile object is able to travel, which is captured with an inclination with respect to the surface,
generating a low-resolution image obtained by lowering image quality of the captured image,
defining a plurality of partial area sets each having partial areas in the low-resolution image, and
deriving a total value obtained by totalizing differences in feature amount between the partial areas included in each of the plurality of partial area sets and partial areas in the vicinity to extract a point of interest on the basis of the total value,
each of the plurality of partial area sets is defined to include a plurality of partial areas in a target area of each partial area set, and
the target area is obtained by cutting out a part of the low-resolution image limited in a vertical direction so that at least a part thereof does not overlap with another partial area set in the vertical direction.
